(19) United States
(12) Patent Application Publication
(10) Pub. No.: US 2026/0280303 A1
(43) Pub. Date: Sep. 17, 2026

(54) METHOD FOR CONNECTING DEVICES TO NETWORK, AND PHOTOVOLTAIC SYSTEM

(71) Applicant: HANWHA SOLUTIONS CORPORATION, Seoul (KR)

(72) Inventors: Seung Woo SHIN, Seoul (KR); Jeong Hun WOO, Seoul (KR); Jae Dong LEE, Seoul (KR); Ju Hwan YUN, Seoul (KR); Su Chang LEE, Seoul (KR)

(73) Assignee: HANWHA SOLUTIONS CORPORATION, Seoul (KR)

(21) Appl. No.: 19/469,860

(22) PCT Filed: Mar. 21, 2024
(86) PCT No.: PCT/KR2024/003539

§ 371 Date: Sep. 26, 2025

(30) Foreign Application Priority Data
Mar. 31, 2023 (KR) 10-2023-0042993

(51) Int. Cl. H02J 3/38; H02J 13/13; H02J 101/24; H02S 99/00; H04B 3/54

(52) U.S. Cl. CPC H02J 3/38; H02J 13/13; H02S 99/00; H04B 3/54; H02J 2101/24

(57) ABSTRACT

A system according to an aspect includes a plurality of devices connected to a plurality of solar panels and transmitting request messages each including unique information, while adjusting transmit power and receive sensitivity, and a gateway that receives the request messages from the plurality of devices while adjusting the transmit power and the receive sensitivity, wherein the gateway connects the plurality of devices to a network based on the received request messages each time the transmit power and the receive sensitivity increase stepwise from a lowest value.

### TECHNICAL FIELD

The present disclosure relates to a method of connecting devices to a network, and a photovoltaic system.

### BACKGROUND ART

A photovoltaic system is a system for converting solar energy into electrical energy by using a photovoltaic cell and transmitting the electrical energy to a commercial power grid, and does not generate environmental pollution during such a process and may be used semi-permanently.

In order to monitor a power generation state of a solar panel and increase power generation efficiency, a specific device may be installed on the solar panel. Accordingly, there is a need to inspect a connection state between the solar panel and the device or an operating state of the device.

In the related art, after an installer installs the device on the solar panel, the connection state between the solar panel and the device is inspected by checking whether a light source included in the device is turned on.

Also, in the related art, after the installer installs the device on the solar panel, the installer manually records unique information attached to the device. Then, the installer accesses a commissioning system and inputs the unique information directly to a layout to connect the device to the network and inspect the operating state of the device.

However, according to a method of the related art, a possibility that an error may occur when the device is connected is high, a network connection time increases, and inconvenience to the installer is caused.

In addition, according to the method of the related art, in case that a layout of the installed device and a layout input to the system are different, the installer may have the hassle of visiting an installation site again to check the layout and correct the layout input to the system.

### DISCLOSURE OF INVENTION

### Technical Problem

In order to solve the problems of the related art described above, the present disclosure aims to reduce a possibility that an error may occur when a plurality of devices are connected to a network, reduce a network connection time, and provide convenience to an installer.

The technical problems to be achieved by the present disclosure are not limited to the technical problems mentioned above, and other technical problems that are not mentioned will be clearly understood by one of ordinary skill in the art from the following description.

### Solution to Problem

A system according to an aspect includes a plurality of devices connected to a plurality of solar panels and transmitting request messages each including unique information, while adjusting transmit power and receive sensitivity, and a gateway that receives the request messages from the plurality of devices while adjusting the transmit power and the receive sensitivity, wherein the gateway connects the plurality of devices to a network based on the received request messages each time the transmit power and the receive sensitivity increase stepwise from a lowest value.

A method of connecting a plurality of devices to a network in a photovoltaic system, according to another aspect, includes transmitting, by the plurality of devices, request messages each including unique information, receiving, by a gateway, the request message from a first device closest to the gateway from among the plurality of devices, and connecting the first device to the network, based on identifying that the first device has received a response message transmitted to the first device.

A computer-readable recording medium, according to another aspect, has recorded thereon a program for executing the method on a computer.

### Advantageous Effects of Invention

According to the present disclosure, a plurality of devices may be automatically connected to a network by matching unique information of the plurality of devices to a layout representing the arrangement structure of a plurality of solar panels.

In addition, according to the present disclosure, a possibility that an error may occur when a plurality of devices are connected to a network may be reduced, a network connection time may be reduced, and convenience may be provided to an installer.

The effects obtainable in the present disclosure are not limited to the above-mentioned effects, and other effects not mentioned may be clearly understood by one of ordinary skill in the art from the description below.

### BRIEF DESCRIPTION OF DRAWINGS

FIG. 1 is a diagram illustrating an example of a photovoltaic system according to an embodiment.

FIG. 2 is a block diagram illustrating an example of a main controller according to an embodiment.

FIG. 3 is a diagram illustrating an example of a layout representing an arrangement structure of a plurality of solar panels, according to an embodiment.

FIG. 4 is a flowchart illustrating an example of a method of connecting a device to a network, according to an embodiment.

FIG. 5 is a flowchart illustrating another example of a method of connecting a device to a network, according to an embodiment.

### BEST MODE FOR CARRYING OUT THE INVENTION

A system according to an aspect includes a plurality of devices connected to a plurality of solar panels and transmitting request messages each including unique information, while adjusting transmit power and receive sensitivity, and a gateway that receives the request messages from the plurality of devices while adjusting the transmit power and the receive sensitivity, wherein the gateway connects the plurality of devices to a network based on the received request messages each time the transmit power and the receive sensitivity increase stepwise from a lowest value.

### MODE FOR THE INVENTION

Objective, means, and effects of the present disclosure will become more apparent through the following detailed description with reference to the accompanying drawings, and one of ordinary skill in the art will be able to easily implement technical ideas of the present disclosure accordingly. In the description of the present disclosure, certain detailed explanations of related art are omitted when it is deemed that they may unnecessarily obscure the essence of the present disclosure.

In the present specification, the terms “or,” “at least one,” and the like may refer to one of words listed together or may refer to a combination of two or more. For example, “or B” or “at least one of or B” may include only one of A or B, or may include both A and B.

The terms such as “first,” “second,” etc., in the present specification may be used to describe various components, but such components must not be limited by the above terms. The above terms should not be construed as limiting the order of components, but may be used to distinguish one component from another component.

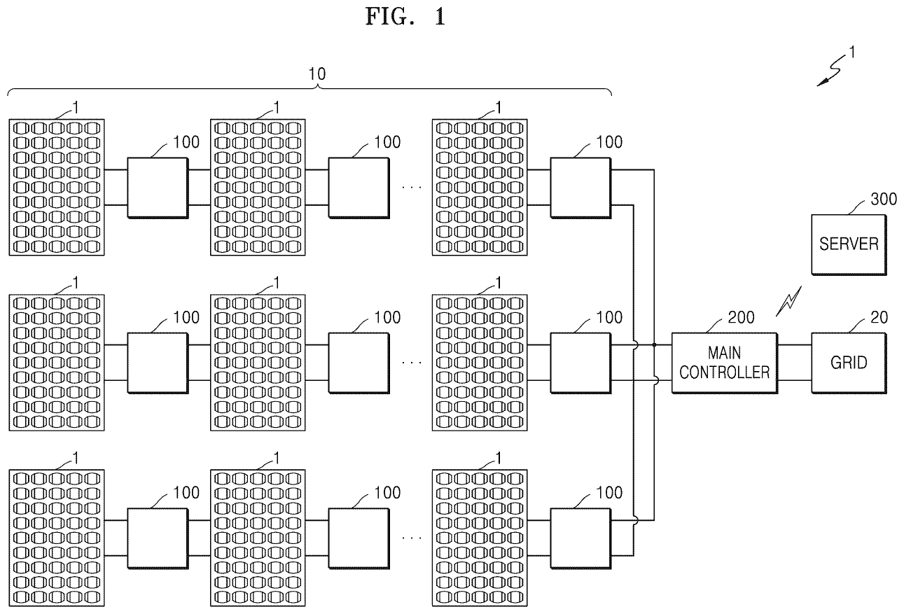

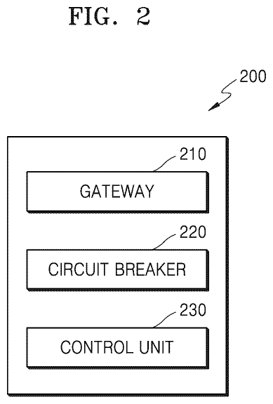

FIG. 1 is a diagram illustrating an example of a photovoltaic system according to an embodiment. Also, FIG. 2 is a block diagram illustrating an example of a main controller according to an embodiment.

Referring to FIG. 1, a photovoltaic system 1 may include a string 10, devices 100, and a main controller 200. Also, when necessary, the system 1 may further include a server 300 and/or a grid 20. The system 1 may further include other general-purpose components in addition to the components shown in FIG. 1.

The string 10 may be configured by connecting a plurality of solar panels 1 in series through power lines. For example, a plurality of the strings 10 may be connected in parallel to each other.

The device 100 may be connected to the solar panel 1. For example, the devices 100 may be connected to respective solar panels 1, and the number of solar panels 1 and the number of devices 100 may be the same in the string 10.

The device 100 may include module level power electronics (MLPE). For example, the device 100 may include an optimizer or a micro inverter. For example, in case that the device 100 includes an optimizer, the device 100 may adjust power generated from the solar panel 1 and output the adjusted power to an inverter (e.g., a string inverter). A current converted by the inverter (e.g., a direct current to an alternating current) may be output to a load or the grid 20. In another example, in case that the device 100 includes a micro inverter, the device 100 may convert power generated from the solar panel 1. A current converted by the device 100 may be output to the load or the grid 20.

For example, the device 100 may transmit, to the main controller 200, a message to connect the solar panel 1 to the network. Also, the device 100 may transmit power generation information of the solar panel 1 to the main controller 200.

The main controller 200 may perform an emergency shutdown (rapid shutdown) to stop power generation of the solar panel 1 during an emergency situation. Accordingly, the main controller 200 may include a circuit breaker that connects the string 10 and the grid 20 to each other or disconnects the string 10 and the load from each other.

Referring to FIG. 2, the main controller 200 may include a gateway 210, a circuit breaker 220, and a control unit 230. The main controller 200 may further include other general-purpose components in addition to the components shown in FIG. 2.

In FIG. 2, the gateway 210, the circuit breaker 220, and the control unit 230 are illustrated as being included in the main controller 200, but are not limited thereto. In other words, the gateway 210, the circuit breaker 220, and the control unit 230 may be implemented as independent devices, or at least some of the gateway 210, the circuit breaker 220, and the control unit 230 may be included in one device.

At least some of operations of the gateway 210 below may be performed by the control unit 230. For example, the gateway 210 may transmit and receive signals between an external device and the main controller 200 according to a command from the control unit 230, and the control unit 230 may perform an operation using the signal received by the gateway 210.

Also, the gateway 210 may include at least one processor.

The main controller 200 may control general operations of the plurality of devices 100. Accordingly, the gateway 210 may collect pieces of power generation information of the plurality of solar panels 1 from the plurality of devices 100 and transmit the power generation information to the server 300. Accordingly, the server 300 may monitor power generation states of the plurality of solar panels 1 by using the received information. For example, information may be transmitted and received between the main controller 200 and the server 300 by using various wired or wireless communication methods.

For example, information may be transmitted and received between the main controller 200 and the server 300 by using a wireless communication method such as 5th generation (5G) communication, long term evolution-advanced (LTE-A), long term evolution (LTE), wireless fidelity (Wi-Fi)), or Bluetooth, or a wired communication method such as a local area network (LAN), a wide area network (WAN), or power line communication.

The main controller 200 may control the device 100 according to the power generation state of the solar panel 1. For example, the gateway 210 may receive a control command from the server 300, and the control unit 230 may control the plurality of devices 100 according to the control command.

For example, the control unit 230 may be implemented as at least one processor. The processor may process a command of a computer program by performing basic arithmetic, logic, and input/output operations. Here, a command may be provided from an internal memory of the main controller 200 or from an external device. Also, the processor may generally control operations of other components included in the main controller 200.

Meanwhile, the processor may perform at least some of data analysis, processing, and result information generation for performing the above-described operations by using at least one of machine learning, a neural network, or a deep learning algorithm, as a rule-based or artificial intelligence algorithm. Examples of the neural network include models such as a convolutional neural network (CNN), a deep neural network (DNN), and a recurrent neural network (RNN).

For example, the processor may be implemented as an array of a plurality of logic gates, or in a combination of a general-purpose microprocessor and a memory storing a program executable by the general-purpose microprocessor. For example, the processor may include a general-purpose processor, a central processing unit (CPU), a microprocessor, a digital signal processor (DSP), a controller, a microcontroller, a state machine, and the like. In some environments, the processor 420 may refer to an application-specific semiconductor (ASIC), a programmable logic device (PLD), a field programmable gate array (FPGA), or the like. For example, the processor may refer to a combination of processing devices, such as a combination of a DSP and a microprocessor, a combination of a plurality of microprocessors, a combination of one or more microprocessors coupled with a DSP core, or a combination of any other such components.

The main controller 200 may include a plurality of circuit breakers 420 and may disconnect the string 10 and the grid 20 during an emergency situation.

For example, information may be transmitted and received between the device 100 and the main controller 200 by using a power line communication (PLC) method, but is not limited thereto.

In order to monitor the power generation state of the solar panel 100 and control the device 100, when the plurality of devices 100 are installed on the plurality of solar panels 1, the plurality of devices 100 need to be connected to the network.

The plurality of devices 100 may be connected to the plurality of solar panels 1. Also, the plurality of devices 100 may transmit, to the gateway 210, request messages each including unique information, to request a network connection. When the gateway 210 receives the request message, the gateway 210 may transmit a response message to the device 100 that has transmitted the request message.

Here, the gateway 210 and the plurality of devices 100 may increase transmit power of a signal (hereinafter referred to as transmit power) and receive sensitivity of the signal (hereinafter referred to as receive sensitivity) stepwise. In detail, the transmit power and the receive sensitivity may be divided into at least two stages from a minumum value to a maximum value. The gateway 210 and the plurality of devices 100 may increase the transmit power and the receive sensitivity step by step.

The gateway 210 may receive the request messages from the plurality of devices 100 whenever the transmit power of the plurality of devices 100 and the receive sensitivity of the gateway 210 are increased stepwise. At this time, the gateway 210 may receive a request message from a device closest to the gateway 210 from among the plurality of devices 100.

Also, the gateway 210 may transmit a response message to the plurality of devices 100 based on the received request message, whenever the transmit power of the plurality of devices 100 and the receive sensitivity of the gateway 210 are increased stepwise.

The gateway 210 may identify whether the plurality of devices 100 have received the response message and connect the plurality of devices 100 to the network, whenever the transmit power and the receive sensitivity of the gateway 210 are increased stepwise. At this time, only the device closest to the gateway 210 from among the plurality of devices 100 may receive the response message.

The gateway 210 may connect the plurality of devices 100 to the network by matching the unique information to a layout 30 representing an arrangement structure of the plurality of solar panels 1.

In case that the gateway 210 receives the request messages from at least two devices from among the plurality of devices 100, the gateway 210 may connect a device to the network based on at least one of a signal-to-noise ratio (SNR) or a link quality indicator (LQI) of the request message.

In case that the gateway 210 receives the request messages from at least two devices from among the plurality of devices 100, and the SNRs and LQIs of the request messages are the same, the gateway 210 transmits the response message to each of the at least two devices (i.e., the devices corresponding to the request messages received by the gateway 210). Also, the gateway 210 may connect a device to the network based on identifying whether the at least two devices (i.e., the devices to which the gateway 210 has transmitted the response message) have received the response message.

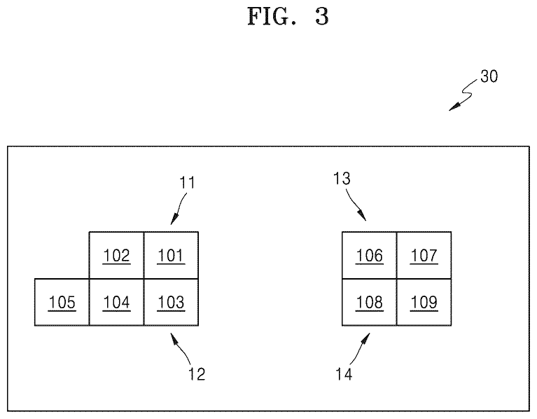

FIG. 3 is a diagram illustrating an example of a layout representing an arrangement structure of a plurality of solar panels, according to an embodiment.

For convenience of description, FIG. 3 illustrates a total of nine devices 101 to 109 and a total of four strings 11 to 14, but the numbers thereof are not limited thereto. In other words, the numbers of devices and strings may be more or less. Also, it is assumed that the gateway 210 is located at the center of the layout 30.

Referring to FIG. 3, a first device 101 and a second device 102 are provided in a first string 11, a third device 103 to a fifth device 105 are provided in a second string 12, a sixth device 106 and a seventh device 107 are provided in a third string 13, and an eighth device 108 and a ninth device 109 are provided in a fourth string 14. Here, it is assumed that transmit power and receive sensitivity of the devices 101 to 109 and the gateway 210 are set to the lowest.

An installer may input the number (9) of devices 101 to 109 to the gateway 210.

The control unit 230 may turn on the circuit breaker 220 connected to the first string 11 to connect the first device 101 and the second device 102 to the grid 20. Accordingly, power may be supplied to the first device 101 and the second device 102. At this time, the circuit breaker 220 connected to the second string 12 to the fourth string 14 may be in an off state.

When power is supplied to the first device 101 and the second device 102, the first device 101 and the second device 102 may transmit, to the gateway 210, request messages each including unique information to request a network connection. In other words, the first device 101 may transmit a first request message to the gateway 210, and the second device 102 may transmit a second request message to the gateway 210. At this time, the first device 101 and the second device 102 may retransmit the request messages to the gateway 210 until a response message is received from the gateway 210.

Because the transmit power of the first device 101 and the second device 102, and the receive sensitivity of the gateway 210 are set to the lowest, the gateway 210 may receive the first request message only from the first device 101 that is closer to the gateway 210 from among the first device 101 and the second device 102.

In case that the gateway 210 receives the first request message only from the first device 101, the gateway 210 may transmit the response message only to the first device 101.

Even if the transmit power of the first device 101 and the second device 102, and the receive sensitivity of the gateway 210 are set to the lowest, the gateway 210 may receive request messages from both the first device 101 and the second device 102 depending on a communication environment or an installation environment. In other words, the gateway 210 may receive both the first request message and the second request message.

In this case, the gateway 210 may transmit the response message based on at least one of SNRs or LQIs of the first request message and the second request message. For example, the gateway 210 may transmit the response message by comparing the SNRs and the LQIs of the first request message and the second request message.

As illustrated in FIG. 3, because the first device 101 is closer to the gateway 210 than the second device 102, the SNR and the LQI are higher in the first request message than in the second request message. Accordingly, the gateway 210 may only transmit the response message to the first device 101.

In case that the SNRs and the LQIs of the first request message and the second request message are the same or differences thereof are less than a reference value, the gateway 210 may transmit a first response message to the first device 101 and a second response message to the second device 102.

In this case, because the transmit power of the gateway 210 and the receive sensitivity of the first device 101 and the second device 101 and 102 are set to the lowest, only the first device 101 that is closer to the gateway 210, from among the first device 101 and the second device 102, may receive the first response message.

When the first device 101 receives the first response message, the first request message is no longer transmitted to the gateway 210. Also, for smooth communication, the transmit power and the receive sensitivity of the first device 101 are set to maximum.

In case that the gateway 210 no longer receives the first request message from the first device 101, the gateway 210 connects the first device 101 to the network. In other words, the gateway 210 connects the first device 101 to the network by matching the unique information of the first device 101 to a first solar panel location of the first string 11 in the layout 30. Then, the gateway 210 increases the number of devices connected to the network.

Because the second device 102 has not received the second response message from the gateway 210, the second device 102 retransmits the second request message to the gateway 210.

In case that the gateway 210 does not receive the second request message from the second device 102 for a first reference time (e.g., 30 seconds) from a time point when the first device 101 has been connected to the network, the gateway 210 and the second device 102 increase the transmit power and the receive sensitivity by one stage. For example, a range of the transmit power may be 0×00 to 0×20, and a range of the receive sensitivity may be 0×00 to 0×1F, but the ranges are not limited thereto. Stages of the transmit power and the receive sensitivity may be set by dividing the ranges of the transmit power and receive sensitivity into pluralities of ranges.

The gateway 210 may receive the second request message from the second device 101 after the transmit power of the second device 101 and 102 and the receive sensitivity of the gateway 210 are increased by one stage. At this time, the second request message may be transmitted to the gateway 210 via the first device 101 connected to the network. Accordingly, the second request message may include the unique information of the first device 101.

The gateway 210 may use, as path information, the unique information of the first device 101 included in the second request message. For example, in case that the second request message includes the unique information of the first device 101, the gateway 210 may determine that the second device 101 is included in the first string 11.

In case that the second request message is received from the second device 102, the gateway 210 transmits the second response message to the second device 102.

When the second device 102 receives the second response message, the second device 102 no longer transmits the second request message to the gateway 210. Also, for smooth communication, the transmit power and the receive sensitivity of the second device 102 are set to maximum.

When the gateway 210 no longer receives the second request message from the second device 102, the gateway 210 identifies the unique information of the second device 102 included in the second request message and connects the second device 102 to the network. For example, the gateway 210 connects the second device 102 to the network by matching the unique information of the second device 102 to a second solar panel location of the first string 11 in the layout 30. Then, the gateway 210 increases the number of devices connected to the network.

When a second reference time (e.g., 2 minutes) elapses after the first string 11 and the grid 20 are connected to each other, the control unit 230 turns on the circuit breaker 220 connected to the second string 12 to connect the third device 103 to the fifth device 105 to the grid 20. Accordingly, power is supplied to the second string 12. At this time, the circuit breaker 220 connected to the third and fourth strings 13 and 14 may be in an off state.

Hereinafter, a method of connecting the second device 102 to the fifth device 105 to the network will be described based on an assumption that the second device 102 is not connected to the network and that the transmit power and the receive sensitivity of the gateway 210 and the second device 102 to the fifth device 105 have been increased by one stage. However, depending on the number of devices 100 included in the first string 11 and the second reference time, the second device 102 may be connected to the network, and the transmit power and the receive sensitivity of the gateway 210 and the third device 103 to the fifth device 105 may have been increased by two or more stages.

When power is supplied to the third device 103 to the fifth device 105, the third device 103 to the fifth device 105 transmit, to the gateway 210, request messages each including unique information to request a network connection. In other words, the third device 103 may transmit a third request message to the gateway 210, the fourth device 104 may transmit a fourth request message to the gateway 210, and the fifth device 105 may transmit a fifth request message to the gateway 210. Here, the third device 103 to the fifth device 105 may retransmit the request messages until a response message is received from the gateway 210.

The gateway 210 may receive the second request message from the second device 102 of the first string 11, and may receive the third request message from the third device 103 that is closest to the gateway 210 from among the third device 103 to the fifth device 105 of the second string 12.

At this time, because the second request message is transmitted to the gateway 210 via the first device 101 connected to the network, the second request message includes the unique information of the first device 101.

The gateway 210 may use, as the path information, the unique information of the first device 101 included in the second request message. In other words, in case that the second request message includes the unique information of the first device 101, the gateway 210 may determine that the second device 101 is included in the first string 11.

In case that the gateway 210 receives the second request message from the second device 102, the gateway 210 transmits the second response message to the second device 102.

When the second device 102 receives the second response message, the second request message is no longer transmitted to the gateway 210. For smooth communication, the transmit power and the receive sensitivity of the second device 102 are set to maximum.

When the gateway 210 no longer receives the second request message from the second device 102, the gateway 210 identifies the unique information of the second device 102 included in the second request message and connects the second device 102 to the network. In other words, the gateway 210 connects the second device 102 to the network by matching unique inverter information of the second device 102 to the second solar panel location of the first string 11 in the layout 30. Then, the gateway 210 increases the number of devices connected to the network.

Because the gateway 210 directly receives the third request message without via another device, the third request message does not include unique information of another device. Accordingly, the gateway 210 may determine that the third device 103 is provided in the second string 12 that is different from the first string 11.

In case that the gateway 210 receives the third request message from the third device 103, the gateway 210 transmits a third response message to the third device 103.

Even if the transmit power of the third device 103 to the fifth device 105, and the receive sensitivity of the gateway 210 are set to a first stage, the gateway 210 may receive request messages from all of the third device 103 to the fifth device 105 depending on the communication environment or the installation environment. In other words, the gateway 210 may receive all of the third request message to the fifth request message.

In this case, the gateway 210 may transmit the response message based on at least one of SNRs and LQIs of the third request message to the fifth request message. For example, the gateway 210 may transmit the response message by comparing the SNRs and the LQIs of the third request message to the fifth request message.

As shown in FIG. 3, because the third device 103 is closest to the gateway 210 from among the third device 130 to the fifth device 105, the SNR and the LQI are the highest in the third request message. Accordingly, the gateway 210 may transmit the response message only to the third device 101.

In case that the SNRs and the LQIs of the third request message to the fifth request message are the same or differences thereof are less than the reference value, the gateway 210 may transmit the third response message to the fifth request message to the third device 103 to the fifth device 105.

In this case, because the transmit power of the gateway 210 and the receive sensitivity of the third device 103 to the fifth device 105 are set to the first stage, only the third device 103 that is closest to the gateway 210, from among the third device 103 to the fifth device 105, may receive the third response message.

When the third device 103 receives the third response message, the third request message is no longer transmitted to the gateway 210. Also, for smooth communication, the transmit power and the receive sensitivity of the third device 103 are set to maximum.

When the gateway 210 no longer receives the third request message from the third device 103, the gateway 210 identifies the unique information of the third device 103 included in the third request message and connects the third device 103 to the network. In other words, the gateway 210 connects the third device 103 to the network by matching the unique information of the third device 103 to a first solar panel location of the second string 12 in the layout 30. Then, the gateway 210 increases the number of devices connected to the network.

When the fourth request message and the fifth request message are not received from the fourth device 104 and the fifth device 105 for the first reference time from a time point when the third device 101 has been connected to the network, the gateway 210, the fourth device 104 and the fifth device 104 and 105 increase the transmit power and receive sensitivity to a second stage. Thereafter, the above-described processes are repeated to connect the fourth device 104 and the fifth device 105 to the network.

Then, the gateway 210 may also supply power to the third string 103 and the fourth string 104 every second reference time and connect the same to the network through the processes described above.

Also, the gateway 210 may determine whether the total number of the plurality of devices 100 and the number of devices connected to the network are the same.

If the total number of the plurality of devices 100 and the number of devices connected to the network are different from each other, the gateway 210 may increase the transmit power and receive sensitivity of the gateway 210 and the plurality of devices 100 stepwise until the numbers become the same.

Finally, when the number of the plurality of devices 100 and the number of devices 100 connected to the network become the same, the gateway 210 terminates network connection processes of the plurality of devices 100.

After the network connection processes of the plurality of devices 100 are terminated, the gateway 210 may transmit, to the server 300, information about the string 10 connected to the network, and connection order information of the plurality of devices 100.

As described above, the system 1 automatically matches the unique information of the plurality of devices 100 to the layout representing the arrangement structure of the plurality of solar panels 1, so that the plurality of devices 100 may be automatically connected to the network.

Accordingly, a possibility that an error may occur when the plurality of devices 100 are connected to the network may be reduced, the network connection time may be reduced, and convenience may be provided to the installer.

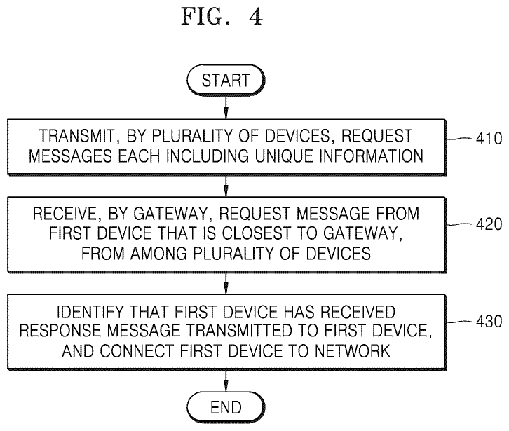

FIG. 4 is a flowchart illustrating an example of a method of connecting a device to a network, according to an embodiment.

The method shown in FIG. 4 includes operations that are processed in time series by the system 1 shown in FIGS. 1 to 3. Accordingly, even if descriptions are omitted below, the details described above with respect to the system 1 may also be applied to the method shown in FIG. 4.

In operation 410, the plurality of devices 100 transmit the request messages each including the unique information.

In operation 420, the gateway 210 receives the request message from a first device that is closest to the gateway 210, from among the plurality of devices 100.

In operation 430, the gateway 210 identifies that the first device has received a response message transmitted to the first device and connects the first device to the network.

For example, the gateway 210 may connect the first device to the network by matching the unique information of the first device to the layout representing the arrangement structure of the plurality of solar panels 1. Here, in case that the request message is transmitted to the gateway 210 via another device connected to the network, the request message may include unique information of the other device.

In case that the request messages are received from at least two devices from among the plurality of devices, the gateway 210 may connect one of the at least two devices to the network based on at least one of SNRs and LQIs of the request messages. At this time, the at least two devices may retransmit the request messages to the gateway 210 until a response message is received from the gateway 210.

Also, the gateway 210 may set transmit power and receive sensitivity of the first device connected to the network to the maximum value.

Although not shown in FIG. 4, the gateway 210 may count the number of devices connected to the network and determine whether the total number of the plurality of devices 100 and the number of devices connected to the network are the same. In case that the number of the plurality of devices 100 and the number of devices connected to the network are different from each other, the gateway 210 may increase the transmit power and the receive sensitivity of the gateway 210 and the plurality of devices 100 stepwise.

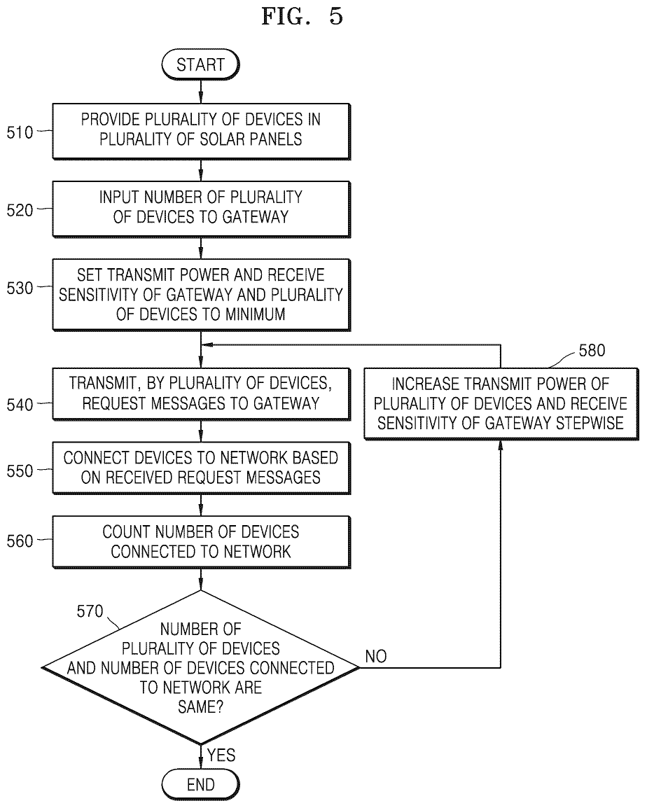

FIG. 5 is a flowchart illustrating another example of a method of connecting a device to a network, according to an embodiment.

The method shown in FIG. 5 includes operations that are processed in time series by the system 1 shown in FIGS. 1 to 3. Accordingly, even if descriptions are omitted below, the details described above with respect to the system 1 may also be applied to the method shown in FIG. 5.

The method shown in FIG. 5 illustrates an example of connecting the plurality of devices 100 to the network by the system 1 including the plurality of strings 10 to which the plurality of solar panels 1 are connected.

In operations 510 to 530, the plurality of devices 100 are provided in the plurality of solar panels 1, and the number of the plurality of devices 100 is input to the gateway 210. Also, the transmit power and receive sensitivity of the gateway 210 and the plurality of devices 100 are set to minimum.

In operation 540, when the plurality of strings 10 are connected to the grid 20, the plurality of devices 100 transmit the request messages each including the unique information to the gateway 210. Then, the gateway 210 receives the request message from the first device that is closest to the gateway 210, from among the plurality of devices 100, whenever the transmit power and the receive sensitivity of the gateway 210 and the plurality of devices 100 are increased stepwise.

In operation 550, the gateway 210 connects devices to the network based on the received request messages.

For example, the gateway 210 transmits the response message to the first device, and when the first device receives the response message, the gateway 210 connects the first device to the network.

In case that two or more request messages are received by the gateway 210 during the first reference time, the gateway 210 may connect one of the plurality of devices 100 to the network based on at least one of the SNRs and the LQIs of the received request messages.

For example, the gateway 210 may connect the first device to the network by matching the unique inverter information of the first device to the layout 30 representing the arrangement structure of the plurality of solar panels 1.

In operation 560, the gateway 210 counts the number of devices connected to the network.

In operation 570, the gateway 210 determines whether the number of the plurality of devices 100 and the number of devices connected to the network are the same.

When the number of the plurality of devices 100 and the number of devices connected to the network are different from each other, the gateway 210 increases the transmit power of the plurality of devices 100 and the receive sensitivity of the gateway 210 stepwise, in operation 580. Then, operation 540 is performed again.

Here, the transmit power of the plurality of devices 100 and the receive sensitivity of the gateway 210 may be increased stepwise for each first reference time.

Operations 540 to 580 are repeated until the number of devices connected to the network becomes the same as the number of the plurality of devices 100.

As described above, the unique inverter information of the plurality of devices 100 is matched to the layout representing the arrangement structure of the plurality of solar panels 1, and thus, the plurality of devices 100 may be automatically connected to the network.

Accordingly, a possibility that an error may occur when the plurality of devices 100 are connected to the network may be reduced, the network connection time may be reduced, and convenience may be provided to the installer.

Meanwhile, the above-described methods may be written as a program executable on a computer, and may be implemented in a general-purpose digital computer operating a program using a computer-readable recording medium. In addition, a structure of data used in the above-described methods may be recorded on a computer-readable medium through various methods. Examples of the computer-readable medium include storage media such as magnetic storage media (for example, read-only memory (ROM), random-access memory (RAM), universal serial bus (USB), floppy disks, and hard disks), and optical readable media (for example, CD-ROM and DVD).

One of ordinary skill in the art will understand that the present disclosure may be implemented in a modified form without departing from the essential features of the present disclosure. Therefore, the disclosed methods should be considered from an explanatory perspective rather than a limited perspective, and the scope of rights is exhibited in the claims, not in the above description, and should be interpreted to include all differences within the equivalent scope.

1. A system comprising:
a plurality of devices connected to a plurality of solar panels and transmitting request messages each including unique information, while adjusting transmit power and receive sensitivity; and
a gateway that receives the request messages from the plurality of devices while adjusting the transmit power and the receive sensitivity,
wherein the gateway
connects the plurality of devices to a network based on the received request messages each time the transmit power and the receive sensitivity increase stepwise from a lowest value.

2. The system of claim 1, wherein
the gateway
receives the request message from a first device closest to the gateway from among the plurality of devices.

3. The system of claim 2, wherein
the gateway
transmits a response message to the first device and connects the first device to the network based on identifying that the first device has received the response message.

4. The system of claim 3, wherein
the gateway
connects the first device to the network by matching unique information of the first device to a layout representing an arrangement structure of the plurality of solar panels.

5. The system of claim 1, wherein the gateway,
in case that the request messages are received from at least two devices from among the plurality of devices, connects one of the at least two devices to the network based on at least one of signal-to-noise ratios or link quality indicators (LQIs) of the request messages.

6. The system of claim 5, wherein
the at least two devices
retransmit the request messages to the gateway until the response message is received from the gateway.

7. The system of claim 6, wherein the gateway,
in case that the request message is not received from the first device after transmitting the response message to the first device, determines that the first device has received the response message.

8. The system of claim 1, wherein
the plurality of devices
set the transmit power and the receive sensitivity to maximum values when connected to the network.

9. The system of claim 1, wherein
the gateway,
in case that the request messages are received from at least two devices from among the plurality of devices and signal-to-noise ratios and link quality indicators (LQIs) of the request messages are the same, transmits a response message to each of the at least two devices and connects one of the at least two devices to the network by identifying whether the at least two devices have received the response message.

10. The system of claim 1, further comprising
a control unit that sequentially connects a plurality of strings to which the plurality of solar panels are connected, to a grid every reference time.

11. The system of claim 10, wherein
the gateway
receives the request message for each string whenever the plurality of strings are sequentially connected to the grid.

12. The system of claim 10, wherein,
in case that the request message is transmitted to the gateway via another device connected to the network, the request message includes unique information of the other device.

13. The system of claim 12, wherein
the gateway
distinguishes the plurality of strings based on unique information of the other device included in the request message.

14. A method of connecting a plurality of devices to a network in a photovoltaic system, the method comprising:
transmitting, by the plurality of devices, request messages each including unique information;
receiving, by a gateway, the request message from a first device closest to the gateway from among the plurality of devices; and
connecting the first device to the network, based on identifying that the first device has received a response message transmitted to the first device.

15. The method of claim 14, wherein
the connecting comprises
connecting the first device to the network by matching unique information of the first device to a layout representing an arrangement structure of a plurality of solar panels.

16. The method of claim 14, wherein
the receiving comprises
receiving the request messages from at least two devices from among the plurality of devices, and
the connecting comprises
connecting one of the at least two devices to the network based on at least one of signal-to-noise ratios or link quality indicators (LQIs) of the request messages.

17. The method of claim 16, wherein
the at least two devices
retransmit the request messages to the gateway until the response message is received from the gateway.

18. The method of claim 14, further comprising
setting transmit power and receive sensitivity of the first device connected to the network to maximum value.

19. The method of claim 14, further comprising:
counting a number of devices connected to the network;
determining whether a total number of the plurality of devices and the number of the devices connected to the network are the same; and
in case that the number of the plurality of devices and the number of the devices connected to the network are different from each other,
increasing transmit power and receive sensitivity of the gateway and the plurality of devices stepwise.

20. A computer-readable recording medium having recorded thereon a program for executing the method of claim 14 on a computer.
